(19) United States
(12) Patent Application Publication
(10) Pub. No.: US 2023/0132609 A1
(43) Pub. Date: May 4, 2023

(54) FLOW-PATH MEMBER USED IN ANALYSIS DEVICE AND LIQUID CHROMATOGRAPH

(71) Applicant: SHIMADZU CORPORATION, Kyoto (JP)

(72) Inventors: Kodai IMAEDA, Kyoto (JP); Masahide GUNJI, Kyoto (JP)

(21) Appl. No.: 17/971,567

(22) Filed: Oct. 22, 2022

(30) Foreign Application Priority Data
Nov. 2, 2021 (JP) 2021-179561

(51) Int. Cl. G01N 30/30

(52) U.S. Cl. CPC G01N 30/30; G01N 2030/027

(57) ABSTRACT

A flow-path member through which a sample flows in an analysis device includes a pipe and a covering member that covers the pipe. The pipe has a first portion including a first direction, which is orthogonal to a direction in which the flow-path member extends as a whole, as at least an element of a local extending direction, a second portion including a second direction, which is opposite to the first direction, as at least an element of a local extending direction, a first bent portion in which a local extending direction changes from the first portion to the second portion, and a second bent portion in which a local extending direction changes from the second portion to the first portion. A space is formed between the covering member and the pipe at least in the first portion and the second portion.

### BACKGROUND

### Technical Field

The present invention relates to a flow-path member used in an analysis device and a liquid chromatograph including the flow-path member.

### Description of Related Art

In a liquid chromatograph, separation columns having small particle diameters have been available in recent years, a peak appearing in a chromatogram is sharper as compared with conventional separation columns and a high separation resolution of a sample can be achieved. With use of such a separation column, many results with excellent separation resolutions can be obtained in a short period of time. On the other hand, however, extra-column dispersion (system dispersion) more greatly influences a theoretical plate number and a peak separation resolution, and dispersion performance of a system has become important in regard to ultra-high performance liquid chromatographs.

It is important to suppress dispersion in a pipe and other components used in a device in order to suppress extra-column dispersion. In JP 2009-276355 A, an attempt is made to provide a liquid chromatograph excellent in separation performance by reducing the internal volume of a flow path around an injection port to suppress extra-column dispersion. In addition, there is a method of using a corrugated pipe as a method of suppressing extra-column dispersion. In the corrugated pipe, it is possible to suppress a difference in flow velocity between a pipe wall-surface portion and a center portion and suppress the extra-column dispersion.

### SUMMARY

As described above, it is possible to improve analysis accuracy in an analysis device by using the corrugated pipe. However, when the corrugated pipe is arranged in a column oven, the temperature of a sample flowing through the corrugated column increases. There is a problem that retention property of a sample in the separation column is degraded when the temperature of the sample increases. In this manner, even in a case in which the corrugated pipe is used, there is a factor that interferes with improvement of analysis accuracy in the analysis device.

An object of the present invention is to provide a flow-path member with which high analysis accuracy in an analysis device can be maintained.

A flow-path member according to one aspect of the present invention which is used in an analysis device and through which a sample flows in the analysis device, includes a pipe, and a covering member that covers the pipe, wherein the pipe has a first portion including a first direction, which is orthogonal to a direction in which the flow-path member extends as a whole, as at least an element of a local extending direction, a second portion including a second direction, which is opposite to the first direction, as at least an element of a local extending direction, a first bent portion in which a local extending direction changes from the first portion to the second portion, and a second bent portion in which a local extending direction changes from the second portion to the first portion, and a space is formed between the covering member and the pipe at least in the first portion and the second portion.

The present invention is also directed to a liquid chromatograph including the flow-path member used in the above-mentioned analysis device.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is an overview of a liquid chromatograph according to the present embodiment;

FIG. 2 is a side view showing a flow-path member according to a first embodiment;

FIG. 3 is a cross sectional side view of an end portion of the flow-path member according to the first embodiment;

FIG. 4 is a diagram for comparison between chromatograms of a corrugated pipe with a covering member and a corrugated pipe without a covering member;

FIG. 5 is a cross sectional side view of an end portion of a flow-path member according to a second embodiment;

FIG. 6 is a cross sectional view taken along the line VI-VI of the flow-path member shown in FIG. 5;

FIG. 7 is a cross-sectional view of a flow-path member according to a modified example of the second embodiment;

FIG. 8 is a diagram for comparison between chromatograms of a corrugated pipe with a covering member and a filling member, and a corrugated pipe without a covering member; and

FIG. 9 is a diagram for explaining the effect of the corrugated pipe.

### DETAILED DESCRIPTION

A flow-path member and a liquid chromatograph according to embodiments of the present invention will now be described with reference to the attached drawings.

### [1] First Embodiment

(1) Configuration of Liquid Chromatograph

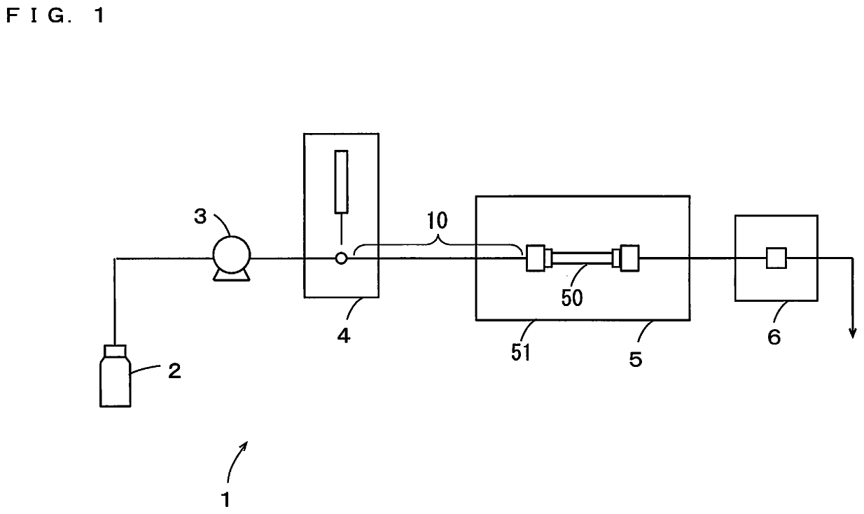

FIG. 1 is a diagram showing a liquid chromatograph 1 which is an analysis device of the present embodiment. The liquid chromatograph 1 includes a solution tank 2, a liquid sending pump 3, an autosampler 4, a column unit 5 and a detector 6. The column unit 5 includes a separation column 50 and a column oven 51. The autosampler 4 and the separation column 50 are connected to each other by the flow-path member 10. The flow-path member 10 extends into the column oven 51 and is connected to an end portion of the separation column 50.

The solution tank 2 stores a solvent which is a mobile phase. The liquid sending pump 3 pumps the solvent stored in the solution tank 2 to an analysis flow path. The autosampler 4 injects a sample into the analysis flow path. The sample that has been injected by the autosampler 4 flows through the flow-path member 10 together with the solvent and is sent to the separation column 50. In the separation column 50, the sample is separated into components based on a difference in magnitude of interaction of a stationary phase. The components into which the sample has been separated in the separation column 50 are detected by the detector 6.

(2) Configuration of Flow-Path Member 10

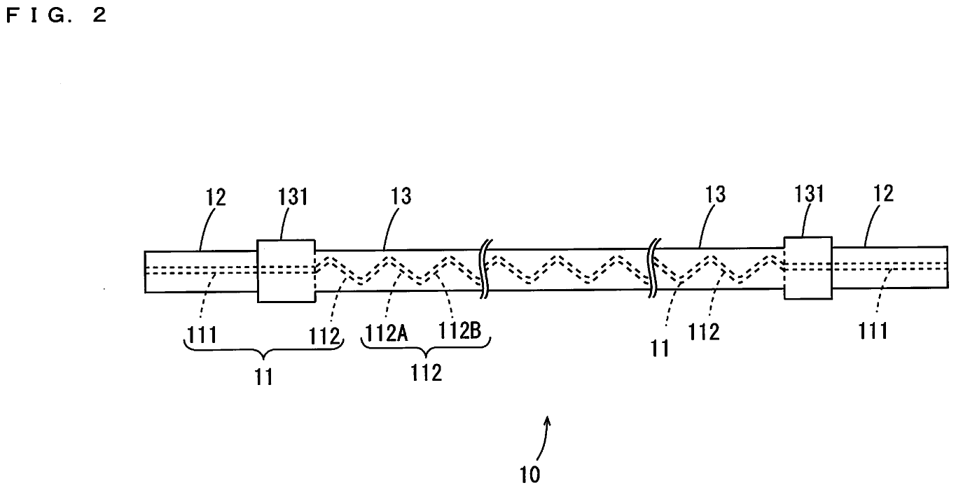

FIG. 2 is a side view of the flow-path member 10 according to a first embodiment. The flow-path member 10 includes a pipe 11, sleeves 12 covering the both end portions of the pipe 11 and a covering member 13 covering the pipe 11 except for part of the both ends of the pipe 11. The pipe 11 includes a straight pipe 111 and a corrugated pipe 112. Straight pipes 111 are provided at both end portions of the pipe 11 and extend linearly in the longitudinal direction of the flow-path member 10. The corrugated pipe 112 extends in a corrugated shape in the longitudinal direction of the flow-path member 10. The straight pipes 111 are connected to the both ends in the longitudinal direction of the corrugated pipe 112.

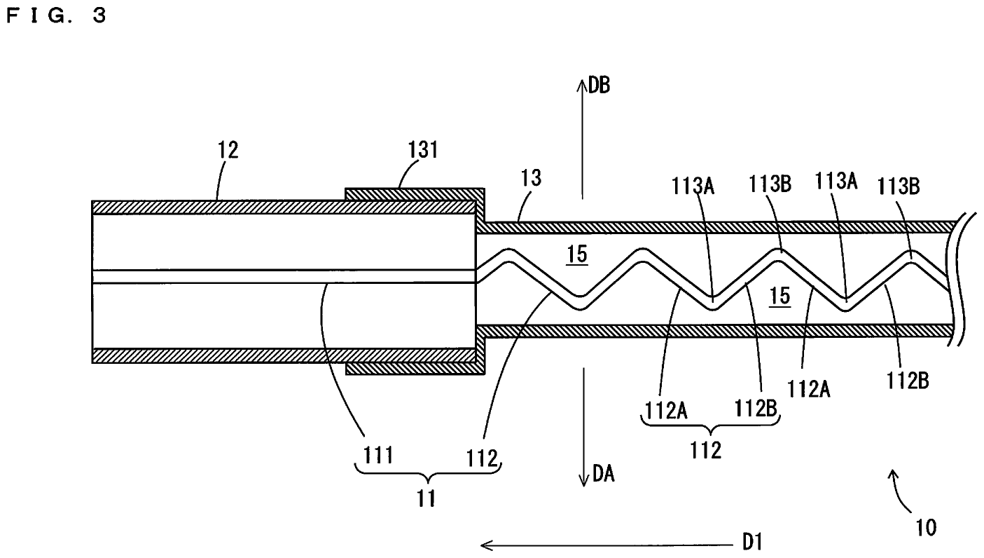

FIG. 3 is a cross sectional side view of an end portion of the flow-path member 10 according to the first embodiment. While FIG. 3 shows one end portion of the flow-path member 10, the both end portions of the flow-path member 10 have the same structure. The sleeve 12 is a cylindrical member. The straight pipe 111 is arranged in the sleeve 12. The flow-path member 10 is connected to the autosampler 4 by the sleeve 12 at one end portion and connected to the separation column 50 by the sleeve 12 at the other end portion. The covering member 13 covers the entire corrugated pipe 112 and part of the sleeve 12. A portion of the covering member 13 covering the sleeve 12 is formed with an enlarged diameter portion 131 having a large diameter. The covering member 13 is made of an elastic member such as a heat-shrinkable tube. For example, a polyolefin resin is used for the covering member 13.

As shown in FIG. 3, the corrugated pipe 112 includes a first portion 112A and a second portion 112B. The first portion 112A includes a first direction DA, which is orthogonal to a direction D1 in which the flow-path member 10 extends as a whole, as at least an element of a local extending direction. The second portion 112B includes a second direction DB, which is opposite to the first direction DA, as at least an element of the local extending direction. In a first bent portion 113A, the extending direction of the corrugated pipe 112 changes from the first portion 112A to the second portion 112B. In a second bent portion 113B, the extending direction of the corrugated pipe 112 changes from the second portion 112B to the first portion 112A. In the present embodiment, the corrugated pipe 112 extends in the direction D1 as a whole while changing the local direction in a plane including the first direction DA and the second direction DB. Further, because many first bent portions 113A and second bent portions 113B are provided, the corrugated pipe 112 extends while changing its local extending direction multiple times.

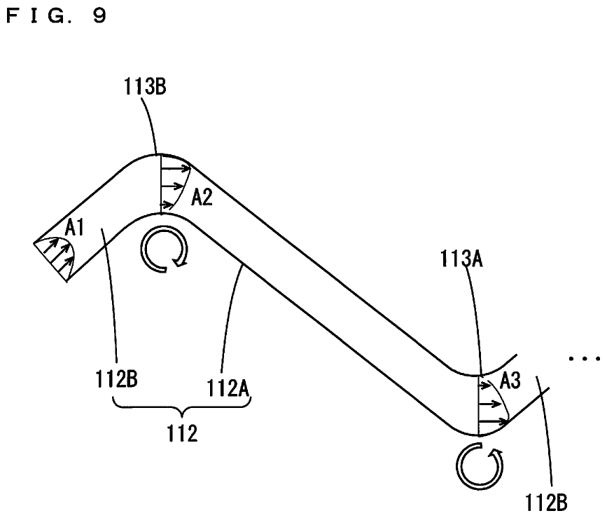

FIG. 9 is a diagram showing the effect of the corrugated pipe 112. In A1, A2 and A3 in the diagram, the flow velocities of a mobile phase flowing through the corrugated pipe 112 are indicated by the lengths of the arrows. As shown in A1, in a portion in which the pipe 11 extends linearly, the flow velocities in the portions close to the wall surface are lower than the flow velocity in the center portion. This difference in flow velocity causes extra-column dispersion. As indicated in A2, in the second bent portion 113B, the flow velocity in a portion farther outward in the curve is higher than that in a portion farther inward in the curve due to an eddy of a mobile phase generated in the pipe. As indicated in A3, in the first bent portion 113A, the flow velocity in a portion farther outward in the curve is higher than that in a portion farther inward in the curve due to an eddy of a mobile phase generated in the pipe. With such a configuration, the flow velocities in the wall-surface portion and the center portion of the corrugated pipe 112 are averaged, and the difference in flow velocity is reduced. Thus, extra-column dispersion can be suppressed.

As shown in FIG. 2, the entire corrugated pipe 112 is covered with the covering member 13. Thus, as shown in FIG. 3, a space 15 is formed between the corrugated pipe 112 and the covering member 13. As described above, part of the flow-path member 10 is arranged in the column oven 51. The flow-path member 10 arranged in the column oven 51 receives heat from a heater of the column oven 51. Generally, the temperature of the column oven 51 is adjusted to a high temperature such as 40 degrees. However, because being formed between the corrugated pipe 112 and the covering member 13, the space 15 forms an air layer and functions as a heat insulating layer against the heat of the column oven 51. Thus, it is possible to suppress an increase in temperature of a sample in the flow-path member 10 leading to the separation column 50 and maintain high separation performance in the separation column 50. That is, it is possible to avoid a phenomenon in which the temperature of a sample increases and it is difficult for column particles to retain sample components. In this manner, the flow-path member 10 of the present embodiment can maintain high separation performance in the separation column 50 by forming an air layer using the covering member 13 while suppressing extra-column dispersion by having the corrugated pipe 112.

Further, because the entire corrugated pipe 112 is covered with the covering member 13, it is possible to protect the corrugated pipe 112. Thus, durability of the flow-path member 10 can be enhanced. Further, the covering member 13 is provided across the sleeve 12 and the first portion 112A or the sleeve 12 and the second portion 112B. Thus, the sleeve 12 and the corrugated pipe 112 are prevented from being bent excessively, so that the flow-path member 10 is prevented from being damaged.

(3) Result of Measurement

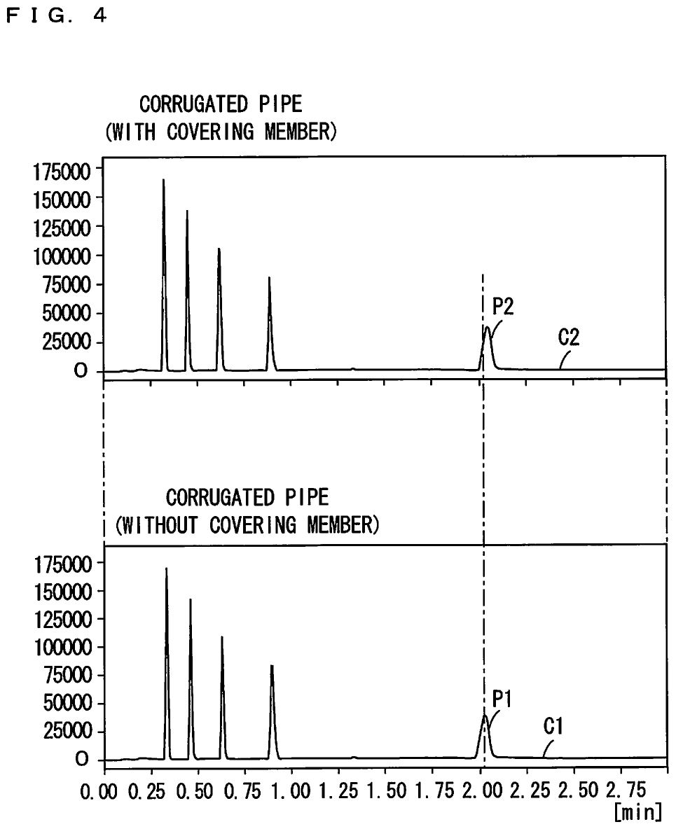

FIG. 4 is a diagram comparing the results of measurement in regard to a same sample under same analysis conditions obtained by the liquid chromatograph 1 of the first embodiment and a liquid chromatograph having a corrugated pipe that is not covered with a covering member. A chromatogram C1 in the lower field of FIG. 4 shows a result of analysis measured in the liquid chromatograph having a corrugated pipe that is not covered with a covering member. A chromatogram C2 in the upper field of FIG. 4 shows a result of analysis measured in the liquid chromatograph 1 of the first embodiment, that is, with use of the corrugated pipe covered with a covering member. It is found that, a peak P2 in the chromatogram C2 has a longer retention time than a peak P1 in the chromatogram C1, and a theoretical plate number and peak separation resolution are improved. Further, it is found that a peak height of each peak in the chromatogram C2 is equal to or higher than that of each peak in the chromatogram C1.

### [2] Second Embodiment

(1) Configuration of Flow-Path Member 10

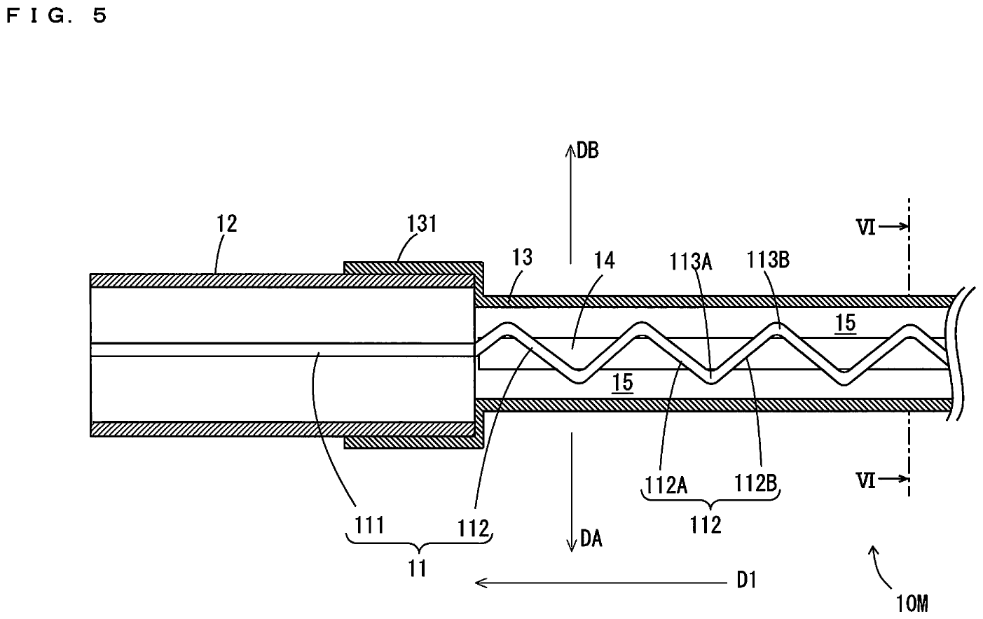

FIG. 5 is a cross sectional side view of an end portion of a flow-path member 10M according to a second embodiment. Differently from the flow-path member 10 of the first embodiment, the flow-path member 10M of the second embodiment is provided with a filling member 14 in a covering member 13. The configuration of the flow-path member 10M is similar to that of the flow-path member 10 shown in FIG. 2 except for provision of the filling member 14. The configuration of the rest of the liquid chromatograph 1 is similar to that shown in FIG. 1 except for provision of the filling member 14. As shown in FIG. 5, the filling member 14 extends linearly substantially parallel to the direction D1 in which the flow-path member 10M extends. The filling member 14 is a metal member, for example.

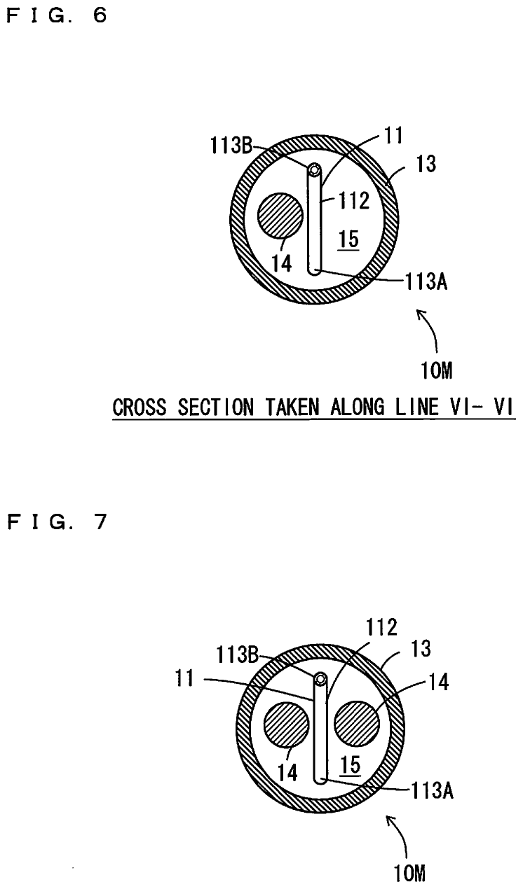

FIG. 6 is a cross sectional view taken along the line VI-VI of the flow-path member 10M shown in FIG. 5. As shown in the diagram, the filling member 14 is arranged next to the corrugated pipe 112. Because the filling member 14 is arranged in the space 15, the space volume of the space 15 is smaller than that of the first embodiment. Alternatively, as shown in FIG. 7, the two filling members 14 may be arranged with a corrugated pipe 112 interposed therebetween. Thus, the space volume of the space 15 is further reduced.

In this manner, with the flow-path member 10M of the second embodiment, the volume of an air layer formed in the covering member 13 can be reduced. In the first embodiment, an air layer is ensured in the covering member 13, and an increase in temperature of a sample caused by the heat of the column oven 51 is suppressed. However, a user who has replaced a conventional liquid chromatograph with the liquid chromatograph 1 of the first embodiment wishes to make a comparison in regard to a specific analysis process under the same conditions as those with which a result of conventional measurement is obtained. As such, in regard to such a wish of the user, comparison with a result of conventional measurement is enabled with use of the flow-path member 10M. Further, it is possible to improve the strength of the flow-path member 10M by inserting the filling member 14 into the covering member 13.

(2) Result of Measurement

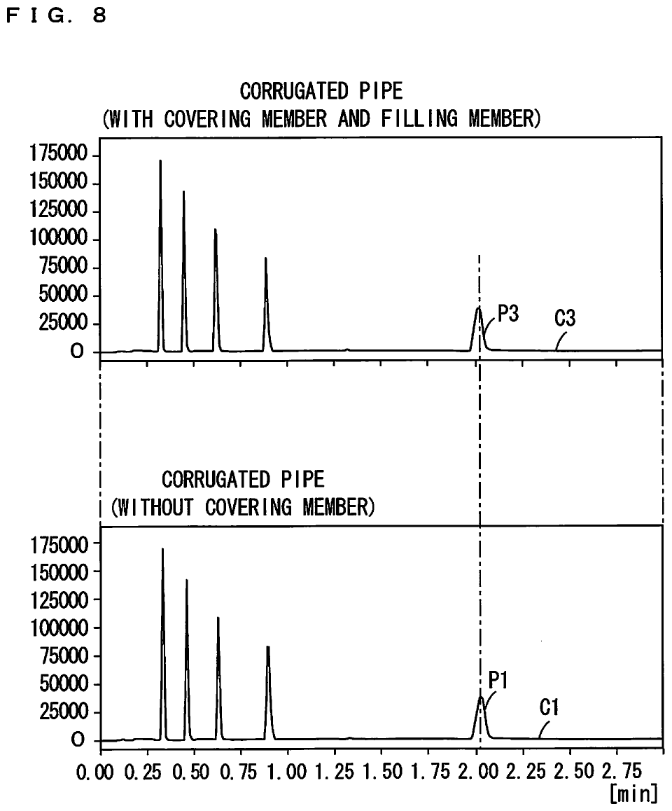

FIG. 8 is a diagram for comparison between the results of measurement obtained by the liquid chromatograph 1 of the second embodiment and a liquid chromatograph having a corrugated pipe that is not covered with a covering member in regard to the same sample under the same analysis conditions. A chromatogram C1 in the lower field of FIG. 8 shows a result of analysis measured in the liquid chromatograph having a corrugated pipe that is not covered with a covering member. A chromatogram C3 in the upper field of FIG. 8 shows a result of analysis measured in the liquid chromatograph 1 of the second embodiment, that is, with use of the corrugated pipe that is covered with the covering member and provided with the filling member. It is found that a peak P3 in the chromatogram C3 has almost equal retention time to that of a peak P1 in the chromatogram C1.

### [3] Modified Example

In the above-mentioned embodiment, the first portion 112A and the second portion 112B of the corrugated pipe 112 are arranged in the plane including the first direction DA and the second direction DB, by way of example. However, the first portion 112A and the second portion 112B do not have to be arranged in the same plane. The first portion 112A may include the first direction DA as at least an element of the extending direction, and the second portion 112B may include the second direction DB as at least an element of the extending direction.

In the present embodiment, the space 15 is formed not only on the outer peripheries of the first portion 112A and the second portion 112B but also on the outer peripheries of the first bent portion 113A and the second bent portion 113B. That is, in FIG. 3, the space 15 is also formed in a portion located farther forward in the first direction DA than the first bent portion 113A and a portion located farther forward in the second direction DB than the second bent portion 113B. However, this is merely one example, and the space 15 may be formed at least on the outer peripheries of the first portion 112A and the second portion 112B.

In the second embodiment, the filling member 14 is a bar member having a substantially circular cross section, by way of example. This is merely one example, and the cross sectional shape of the filling member 14 may be another shape. For example, it is possible to further reduce the volume of an air layer by making the cross sectional shape of the filling member 14 be close to that of the space 15.

### [4] Aspects

It will be appreciated by those skilled in the art that the exemplary embodiments described above are illustrative of the following aspects.

(Item 1)

A flow-path member according to one aspect which is used in an analysis device and through which a sample flows in the analysis device, includes a pipe, and a covering member that covers the pipe, wherein the pipe has a first portion including a first direction, which is orthogonal to a direction in which the flow-path member extends as a whole, as at least an element of a local extending direction, a second portion including a second direction, which is opposite to the first direction, as at least an element of a local extending direction, a first bent portion in which a local extending direction changes from the first portion to the second portion, and a second bent portion in which a local extending direction changes from the second portion to the first portion, and a space is formed between the covering member and the pipe at least in the first portion and the second portion.

It is possible to provide a flow-path member with which high analysis accuracy can be maintained in an analysis device.

(Item 2)

The flow-path member which is used in an analysis device according to item 1, wherein the analysis device may include an autosampler and a separation column, and the flow-path member may connect the autosampler and the separation column to each other.

Extra-column dispersion in the flow path between the autosampler and the separation column can be reduced.

(Item 3)

The flow-path member which is used in an analysis device according to item 2, wherein an end portion connected to the separation column of the flow-path member may be arranged in a column oven.

The space formed in the covering member functions as a heat insulating layer, and an increase in temperature of a sample due to the heat of the column oven can be reduced.

(Item 4)

The flow-path member which is used in an analysis device according to any one of items 1 to 3, wherein the covering member may be constituted by an elastic member.

The covering member can be attached to fit the shape of the flow-path member.

(Item 5) The flow-path member which is used in an analysis device according to item 4, wherein a sleeve having a diameter larger than diameters of the first portion and the second portion may be provided at an end portion of the pipe, and the covering member may be provided across the sleeve and the first portion, or the sleeve and the second portion.

It is possible to prevent the pipe from being excessively bent with respect to the sleeve and improve durability of the flow-path member.

(Item 6)

The flow-path member which is used in an analysis device according to any one of items 1 to 5, wherein a filling member for reducing a volume of the space may be arranged in the covering member.

It is easy to compare a result of analysis performed by the analysis device having this flow-path member with a result of analysis obtained by a conventional analysis device.

(Item 7)

The flow-path member which is used in an analysis device according to item 6, wherein the filling member may be a bar member extending substantially parallel to a direction in which the flow-path member extends as a whole.

The filling member can be inserted along the flow-path member.

(Item 8)

A liquid chromatograph according to another aspect of the present invention includes the flow-path member which is used in an analysis device according to any one of items 1 to 7.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A flow-path member which is used in an analysis device and through which a sample flows in the analysis device, comprising:
a pipe; and
a covering member that covers the pipe, wherein
the pipe has
a first portion including a first direction, which is orthogonal to a direction in which the flow-path member extends as a whole, as at least an element of a local extending direction,
a second portion including a second direction, which is opposite to the first direction, as at least an element of a local extending direction,
a first bent portion in which a local extending direction changes from the first portion to the second portion, and
a second bent portion in which a local extending direction changes from the second portion to the first portion, and
a space is formed between the covering member and the pipe at least in the first portion and the second portion.

2. The flow-path member which is used in an analysis device according to claim 1, wherein
the analysis device includes an autosampler and a separation column, and
the flow-path member connects the autosampler and the separation column to each other.

3. The flow-path member which is used in an analysis device according to claim 2, wherein
an end portion connected to the separation column of the flow-path member is arranged in a column oven.

4. The flow-path member which is used in an analysis device according to claim 1, wherein
the covering member is constituted by an elastic member.

5. The flow-path member which is used in an analysis device according to claim 4, wherein
a sleeve having a diameter larger than diameters of the first portion and the second portion is provided at an end portion of the pipe, and the covering member is provided across the sleeve and the first portion, or the sleeve and the second portion.

6. The flow-path member which is used in an analysis device according to claim 1, wherein
a filling member for reducing a volume of the space is arranged in the covering member.

7. The flow-path member which is used in an analysis device according to claim 6, wherein
the filling member is a bar member extending substantially parallel to a direction in which the flow-path member extends as a whole.

8. A liquid chromatograph comprising the flow-path member which is used in an analysis device according to claim 1.
